(19) United States
(12) Patent Application Publication
(10) Pub. No.: US 2006/0055307 A1
(43) Pub. Date: Mar. 16, 2006

(54) Green light-emitting fluorescent material and fluorescent lamp using same

(76) Inventors: Ryo Yoshimatsu, Shinagawa-ku (JP); Hisashi Yoshida, Shinagawa-ku (JP)

Correspondence Address: SUGHRUE MION, PLLC, 2100 PENNSYLVANIA AVENUE, N.W., SUITE 800, WASHINGTON, DC, 20037, US

(21) Appl. No.: 10/543,206

(22) PCT Filed: Jan. 23, 2004
(86) PCT No.: PCT/JP04/00591

§ 371 Date: Jul. 22, 2005

(30) Foreign Application Priority Data
Jan. 23, 2003 (JP) 2003-015013
Dec. 5, 2003 (JP) 2003-407452
Jan. 14, 2004 (JP) 2004-006254

(51) Int. Cl. H01J 1/62; H01J 63/04; C09K 11/08

(52) U.S. Cl. 313/485; 313/486; 313/487; 252/301.4 R

(57) ABSTRACT

An object of the present invention is to provide a green light-emitting fluorescent material which efficiently absorbs lights, has a short afterglow time and emits a green light when an ultraviolet light at a wavelength of 254 nm sent forth by the mercury discharge is used as an excitation source, and a fluorescent lamp with a short response time. A green light-emitting fluorescent material of the present invention is a fluorescent material comprising, at least, calcium, yttrium, aluminum and oxygen, with terbium as an activator at an emission center. This green light-emitting fluorescent material has a composition expressed by the general formula CaY₁₋ₓTbₓAlO₄ (wherein 0.005≦x≦0.5). Further, Gadolinium and/or lanthanum is, in part, substituted for yttrium and has a composition expressed by the general formula CaY_{1-x-y}TbₓRe_{y}AlO₄ (wherein Re is at least one sort of elements selected between Gd and La, and 0.005≦x≦0.5, 0.1≦y≦0.7). Further, this green light-emitting fluorescent material also efficiently absorbs an ultraviolet light in a wavelength region around 240 nm and, being excited, emits a light.

### FIELD OF THE INVENTION

The present invention relates to a green light-emitting fluorescent material and a fluorescent lamp therewith, and more particularly to a green light-emitting fluorescent material having a short afterglow time and a fluorescent lamp therewith.

### DESCRIPTION OF THE RELATED ART

For the fluorescent material in the general fluorescent lamp and the three emission bands type cold-cathode fluorescent lamp using the mercury emission line as an excitation source, a mixture of fluorescent materials of three colors, namely, red light-emitting, green light-emitting and blue light-emitting fluorescent materials is currently in use. Among these fluorescent materials, the green light-emitting fluorescent material is known to have the emission characteristics which particularly affect the light flux and the color rendering properties of the fluorescent lamp itself. As for such a green light-emitting fluorescent material, a Tb activated phosphate fluorescent material LaPO₄: Ce, Tb has been widely used due to its high emission intensity (For instance, see Patent Literature 1 and Patent Literature 2). [Patent Literature 1] Japanese Patent application Laid-open No.3837/2002 [Patent Literature 2] Japanese Patent application Laid-open No.56812/2002

The LaPO₄: Ce, Tb fluorescent material has an emission peak at a wavelength of 548 nm, providing a sharp emission line, but its afterglow lasts disadvantageously long.

In the lighting system equipped with the fluorescent lamp in which the inner surface of the tube is coated with the fluorescent material, the inverter electronic driver circuit at a frequency of 45 Khz, which makes little flicker, has recently become in wide use, replacing the conventional driver circuit at a frequency of 50/60 Hz with a stabilizer. Further, in the driver circuit of the cold-cathode mercury fluorescent lamp used for the back lighting in the liquid crystal display apparatus, the inverter electronic driver circuit has been also being used. The use of such an inverter electronic driver circuit at a frequency of 45 Khz certainly increases the repetitive lighting frequency of the fluorescent lamp, but because the conventional LaPO₄: Ce, Tb fluorescent material has an afterglow that is long in duration, a problem of slow response arises for the fluorescent lamp wherein the LaPO₄: Ce, Tb fluorescent material is used, and a green light-emitting fluorescent material with a short afterglow time has been being earnestly sought after.

In light of the above problems, an object of the present invention is to provide a green light-emitting fluorescent material which efficiently absorbs lights, has a short afterglow time and emits a green light when an ultraviolet light at a wavelength of 254 nm sent forth by the mercury discharge is used as an excitation source, and a fluorescent lamp with a short response time.

### SUMMARY OF THE INVENTION

The present invention relates to a fluorescent material which efficiently absorbs an ultraviolet light in a wavelength region around 240 nm and has green light-emitting characteristics of having main emission peaks at 548 nm, 487 nm and 585 nm with short afterglow properties. The present invention, further, relates to a fluorescent lamp whose afterglow is made, through the use of such a fluorescent material, much shorter in duration than the conventional ones.

### BRIEF DESCRIPTION OF THE DRAWINGS

FIG. 1 is a graphic representation showing the characteristics of the emission intensity and the excitation intensity of a green light-emitting material CaY_{0.9}Tb_{0.1}AlO₄ according to Example 1, and FIG. 2 is a graphical representation showing the afterglow characteristic of the green light-emitting fluorescent material CaY_{0.9}Tb_{0.1}AlO₄ according to Example 1.

FIG. 3 is a graphic representation showing the characteristics of the emission intensity and the excitation intensity of a green light-emitting material CaY_{0.6}Tb_{0.1}Gd_{0.3}AlO₄ according to Example 2, and FIG. 4 is a graphical representation showing the afterglow characteristic of the green light-emitting fluorescent material CaY_{0.6}Tb_{0.1}Gd_{0.3}AlO₄ according to Example 2.

Further, FIG. 5 is a graphical representation showing the comparison of the excitation spectra of the green light-emitting fluorescent materials according to Example 1, Example 2 and Example 3. FIG. 6 is a graphical representation showing the comparison of the excitation spectra of the green light-emitting fluorescent materials according to Example 1 and Examples 4-7, and FIG. 7 is a graphical representation showing the comparison of the emission spectra of the green light-emitting fluorescent materials according to Example 1 and Examples 4-7.

FIG. 8 is a graphical representation showing the afterglow characteristics of the green light-emitting fluorescent materials according to Example 4 and Example 7.

FIG. 9 is a partially cutaway cross-sectional view, showing the structure of a mercury fluorescent lamp according to one embodiment of the present invention.

Referential numerals used in the drawings are described below.

Referential numeral 11 indicates a glass tube; referential numeral 12, an electrode and referential numeral 13, a fluorescent material film.

### PREFERRED EMBODIMENYS OF THE INVENTION

A green light-emitting fluorescent material of the present invention is a fluorescent material comprising, at least, calcium, yttrium, aluminum and oxygen, with terbium as an activator at an emission center. This green light-emitting fluorescent material has a composition expressed by the general formula CaY₁₋ₓTbₓAlO₄ (wherein 0.005≦x≦0.5), and efficiently absorbs an ultraviolet light in a wavelength region around 240 nm and, being excited, emits a light. Further, this green light-emitting fluorescent material shows emission characteristics of having the main peak at a wavelength of 548 nm and sub-peaks at wavelengths of 487 nm and 585 nm and characteristically its afterglow is shorter in duration than that of the conventional green light-emitting fluorescent materials.

Further, a green light-emitting fluorescent material of the present invention is the afore-mentioned fluorescent material wherein gadolinium and/or lanthanum is, in part, substituted for yttrium and has a composition expressed by the general formula CaY_{1-x-y}TbₓRe_{y}AlO₄ (wherein Re is at least one sort of elements selected between Gd and La, and 0.005≦x≦0.5, 0.1≦y≦0.7). Further, this green light-emitting fluorescent material also efficiently absorbs an ultraviolet light in a wavelength region around 240 nm and, being excited, emits a light. Further, this green light-emitting fluorescent material shows emission characteristics of having the main peak at a wavelength of 548 nm and sub-peaks at wavelengths of 487 nm and 585 nm and characteristically its afterglow is still shorter in duration and its emission intensity is still higher than the afore-mentioned green light-emitting fluorescent material.

Further, a green light-emitting fluorescent material of the present invention has a composition expressed by the general formula CaGd_{1-x-y}La_{y}TbₓAlO₄ (wherein 0.005≦x≦0.5, 0≦y≦1−x). This green light-emitting fluorescent material corresponds to the afore-mentioned green light-emitting fluorescent material expressed by the general formula CaY₁₋ₓTbₓAlO₄ wherein gadolinium and/or lanthanum is substituted for the whole of yttrium, and its crystal structure is different from that of afore-mentioned two green light-emitting fluorescent materials. Because of that, the structure of the excitation band is changed to show a higher efficiency for the mercury emission line at a wavelength of 254 nm. With regard to the emission characteristics including the afterglow characteristic, which are almost similar to those of the afore-mentioned two green light-emitting fluorescent materials, this green light-emitting fluorescent material has the main emission peak at a wavelength of 548 nm and sub-peaks at wavelengths of 487 nm and 585 nm, and has excellent short afterglow property, its afterglow time being approximately ⅓ or so of that of the conventional green light-emitting fluorescent materials.

A fluorescent lamp of the present invention is a fluorescent lamp with a fluorescent material film being formed on the inner surface of a glass tube in which mercury and an inert gas are sealed, wherein the fluorescent material film contains at least the afore-mentioned green light-emitting fluorescent material of the present invention. Further, the fluorescent lamp may have a fluorescent material film formed of a mixture of three sorts of fluorescent materials, with a red light-emitting and a blue light-emitting fluorescent material being added to the green light-emitting fluorescent material of the present invention.

The present inventors examined various fluorescent materials in search of the one that can be used in the mercury fluorescent lamp in which the inert gas containing the mercury vapor is sealed in the inside of the glass tube, and, with an ultraviolet light at a wavelength of 254 nm set forth by mercury being used as an excitation source, can efficiently absorb the light in a wavelength region of that excitation light from the source and emit the visible light in a wavelength region of green color, and found out that a fluorescent material comprising aluminate as the mother material and utilizing terbium as an activator at an emission center meets the above conditions. Now, referring to respective examples, First Embodiment, Second Embodiment and Third Embodiment of the present invention relating to a green light-emitting fluorescent material and Fourth Embodiment of the present invention relating to a mercury fluorescent lamp utilizing such a green light-emitting material are described in detail below.

### FIRST EMBODIMENT

### EXAMPLE 1

Among afore-mentioned green light-emitting fluorescent materials comprising aluminate as the mother material and utilizing terbium as an activator at the emission center, a green light-emitting fluorescent material having a composition expressed by the general formula CaY₁₋ₓTbₓAlO₄ (wherein 0.005≦x≦0.5) is particularly favored, and confirmed to have a shorter afterglow time than the conventional ones.

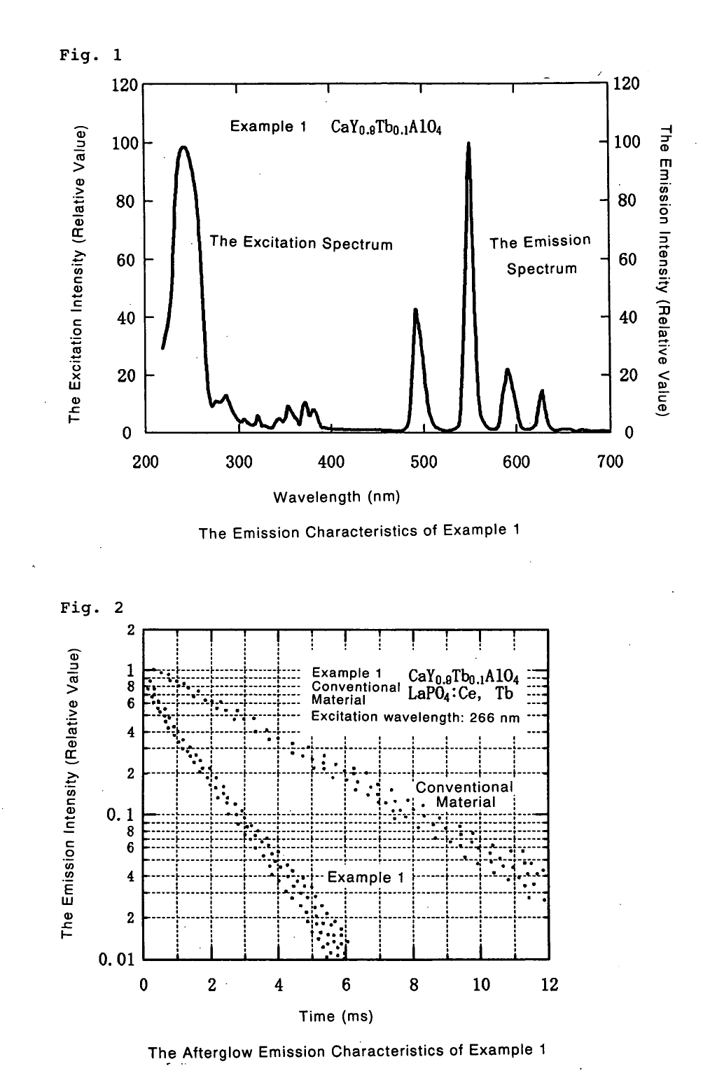

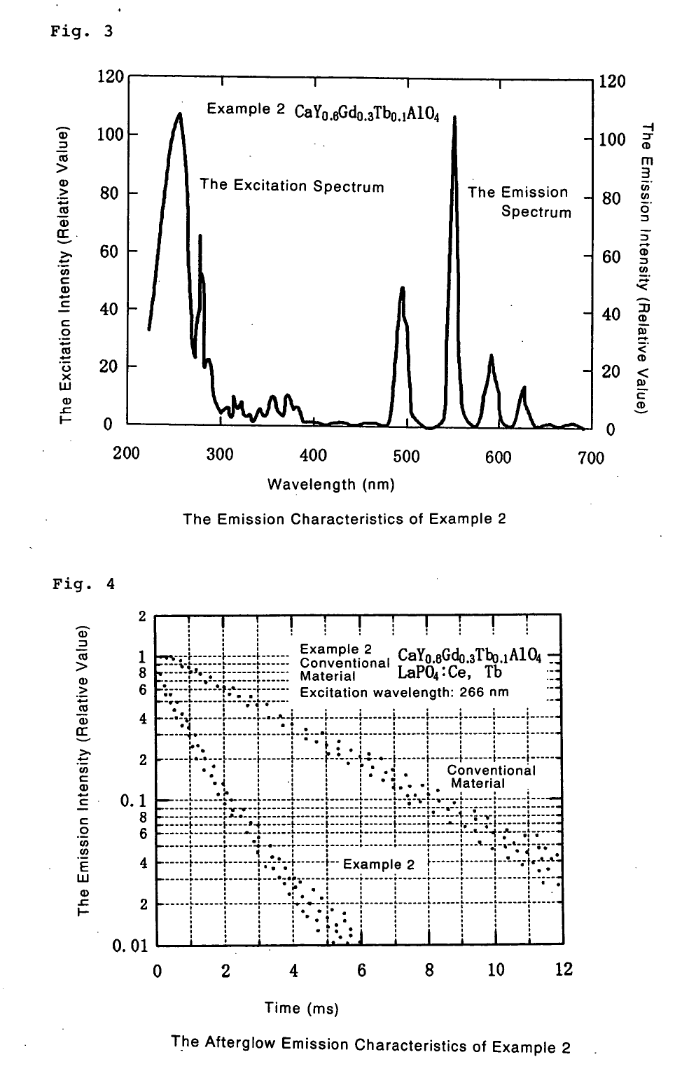

The emission intensity characteristics of the fluorescent material CaY_{0.9}Tb_{0.1}AlO₄, which corresponds to the afore-mentioned green light-emitting fluorescent material CaY₁₋ₓTbₓAlO₄ in the case of a composition value of x=0.1, are shown, together with the excitation intensity characteristics, in FIG. 1. The afterglow characteristics are shown in FIG. 2 and Table 1. In FIG. 1, a curve drawn in a wavelength region between 200 nm and 400 nm shows the excitation spectrum distribution and a curve drawn in a wavelength region between 450 nm and 700 nm, the emission spectrum distribution.

As is evident from FIG. 1, the green light-emitting fluorescent material with this composition CaY_{0.9}Tb_{0.1}AlO₄ efficiently absorbs the ultraviolet light in a wavelength region centering around 240 nm to emit the light. Its emission intensity characteristics have green light-emitting characteristics of having the main peak at a wavelength of 548 nm and sub-peaks at wavelengths of 487 nm and 585 nm. These results indicate this green light-emitting fluorescent material of the present invention is well fitted for application to the mercury fluorescent lamp wherein the ultraviolet light at a wavelength of 254 nm is used as the excitation light.

In comparison of afterglow characteristics between the green light-emitting fluorescent material with the above composition CaY_{0.9}Tb_{0.1}AlO₄ (the composition value of x=0.1) and the conventional green light-emitting fluorescent material LaPO₄:Ce, Tb, the afterglow times (the time between the instant at which the excitation is terminated and the instant at which the emission intensity falls to 1/10 of its initial magnitude) for a CaY_{0.9}Tb_{0.1}AlO₄ fluorescent material of the present example and a conventional LaPO₄:Ce, Tb fluorescent material are 2.8 ms and 7.7 ms, respectively, as given in FIG. 2 and Table 1, and, thus, it is demonstrated that the afterglow of the fluorescent material of the present example is reduced to approximately ⅓ or so in duration, compared with the conventional fluorescent material.

Next, a method of manufacturing a green light-emitting fluorescent material of the present invention is described, taking one with the above composition (the composition value of x=0.1) as an example. The green light-emitting fluorescent material CaY_{0.9}Tb_{0.1}AlO₄ of the present example can be prepared by either the solid-state reaction method or the coprecipitation method, for instance, by baking the starting material in a weakly reducing atmosphere. As an example, the starting material, a CaCO₃ reagent with a purity of 99.99% or higher, Y₂O₃ with a purity of 99.99% or higher, an α-Al₂O₃ reagent with a purity of 99.99% or higher and Tb₄O₇ reagent with a purity of 99.9% or higher are mixed so as to be in the above composition ratio, in other words, CaCO₃, Y₂O₃, α-Al₂O₃ and Tb₄O₇ are mixed in such a way that Ca, Y, Al and Tb may be at the molar ratio of 1:0.9:1:0.1. After that, blending dry or wet, they are baked at approximately 1200-1500° C. for some hours (approximately three hours) and thereby a green light-emitting fluorescent material CaY_{0.9}Tb_{0.1}AlO₄ can be obtained.

Now, with a green light-emitting fluorescent material of the present invention with a composition expressed by the general formula CaY₁₋ₓ,TbₓAlO₄ (wherein 0.005≦x≦0.5), if the composition value x is less than the minimum value of x=0.005, a sufficient emission intensity cannot be attained. On the other hand, if the composition value x is greater than the maximum value of x=0.5, its emission intensity drops due to the concentration quenching and its use becomes less practicable. For these reasons, a range of the composition value x of the present invention is defined to be 0.005≦x≦0.5.

### SECOND EMBODIMENT

Further, the present inventors found out that, in the case of the afore-mentioned green light-emitting fluorescent material having a composition expressed by the general formula CaY₁₋ₓTbₓAlO₄, it is possible to shorten the afterglow time and raise the emission intensity by substituting gadolinium (Gd) and/or lanthanum (La) for one of the compositional elements, yttrium, in part.

In particular, a green light-emitting fluorescent material having a composition expressed by the general formula CaY_{1-x-y}TbₓRe_{y}AlO₄ (wherein Re is at least one sort of elements selected between Gd and La, and 0.005≦x≦0.5, 0.1≦y≦0.7) is favored and it was confirmed such a fluorescent material has a shorter afterglow time and a higher emission intensity than the fluorescent material of Example 1.

### EXAMPLE 2

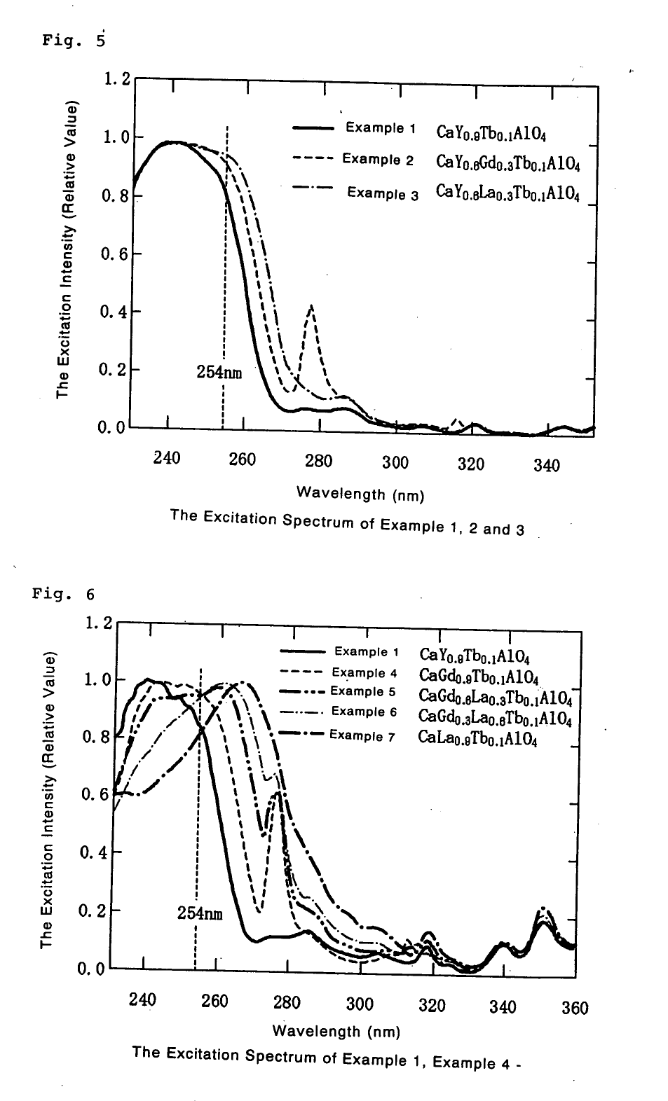

Referring to Example 2, a green light-emitting fluorescent material expressed by the general formula CaY_{1-x-y}TbₓRe_{y}AlO₄ is described below. This Example 2 is a green light-emitting fluorescent material in the case of being expressed by the above general formula wherein x=0.1, Re=Gd and y=0.30, in other words, by the compositional formula CaY0.6Tb_{0.1}Gd_{0.3}AlO₄. The characteristics of emission intensity and excitation intensity of the green light-emitting material of the present example are shown in FIG. 3.

As is evident from FIG. 3, it was confirmed that this green light-emitting fluorescent material efficiently absorbs an ultraviolet light at a wavelength of 240 nm and has the green light-emitting characteristics of having the main peak at an emission wavelength of 548 nm and sub-peaks at emission wavelengths of 487 nm and 585 nm, with the emission structure (the emission peak wavelengths) other than the intensity remaining the same as Example 1. Furthermore, as described below, the emission intensity was observed to be higher than Example 1. A peak somewhere short of a wavelength of 280 nm (276 nm) in the excitation spectrum hereat is characteristic of this example, arising from Gd.

In FIG. 4, there are shown the afterglow characteristic of the green light-emitting fluorescent material CaY_{0.6}Tb_{0.1}Gd_{0.3}AlO₄ of the present example with the afterglow characteristic of the conventional green light-emitting fluorescent material LaPO₄:Ce, Tb for comparison. Further, the afterglow time obtained from this diagram is given in Table 1. The characteristic curve for “the conventional case” in FIG. 4 is the same as the curve for “the conventional case” in FIG. 1. From FIG. 4 and Table 1, it is clear that the afterglow time of the green light-emitting fluorescent material of the present example is 2.2 ms, being reduced to 1/3.5 of that of LaPO₄:Ce, Tb fluorescent material in the conventional case.

### EXAMPLE 3

Next, referring to Example 3, another green light-emitting fluorescent material expressed by the general formula CaY_{1-x-y},Tbₓ,Re_{y}AlO₄ is described below. This Example 3 is a green light-emitting fluorescent material in the case of being expressed by the above general formula wherein x=0.1, Re=La and y=0.30, in other words, by the compositional formula CaY_{0.6}Tb_{0.1}La_{0.3}AlO₄.

Making measurements of the excitation and the emission spectra for the green light-emitting fluorescent material of the present example, the present inventors confirmed the green light-emitting fluorescent material of the present example has the same emission structure as Example 1 and Example 2, that is, the green light-emitting characteristics of having the main peak at an emission wavelength of 548 nm and sub-peaks at emission wavelengths of 487 nm and 585 nm. Moreover, the emission intensity with excitation of an ultraviolet light at a wavelength of 254 nm was observed to be higher than the fluorescent materials of Example 1 and Example 2.

The excitation spectrum of the green light-emitting fluorescent material of Example 3 is shown in FIG. 5, together with those of the green light-emitting fluorescent materials of Example 1 and Example 2 for comparison. This diagram shows the results of the measurements for the green light-emitting fluorescent materials, each measurement made at the emission wavelength where its maximum emission intensity was detected, while varying the excitation wavelength. The ultraviolet light indicated by a longitudinal broken line at a wavelength of 254 nm in the diagram is the mercury emission line, and the strength of the excitation intensity at this wavelength may be considered to be the very strength of the emission intensity that the mercury fluorescent lamp wherein each fluorescent material is utilized in its fluorescent material film has. A peak located at a wavelength of 276 nm in the spectrum of Example 2 in FIG. 5 is, as described above, the peak characteristic of Example 2, arising from Gd. The excitation intensities with the mercury emission line at a wavelength of 254 nm for respective green light-emitting fluorescent materials according to Examples 1-3 are listed in Table 2.

With reference to FIG. 1 and Table 2, it is clear that the substitution of either Gd or La for a part of Y which is a compositional element of the green light-emitting fluorescent material increases the excitation intensity, that is, the emission intensity, and the excitation intensities with the mercury emission line in the case of substitution of Gd (Example 2) and in the case of substitution of La (Example 3) are approximately 15% and 20% higher than that in the case of no substitution (Example 1), respectively.

Next, the investigation of the afterglow time of the green light-emitting fluorescent material of Example 3 with the excitation light at a wavelength of 266 nm was made and the results, as given in Table 1, indicate its afterglow time is 2.5 ms, having almost the middle value between the values of Example 1 (2.8 ms) and Example 2 (2.2 ms).

The green light-emitting fluorescent materials of Example 2 (substitution of Gd for Y) and Example 3 (substitution of La for Y), that is, the green light-emitting fluorescent materials with respective compositions CaY_{1-x-y}TbₓRe_{y}AlO₄ (Re is either Gd or La) may be prepared, as in Example 1, by either the solid-state reaction method or the coprecipitation method, for instance, by baking the starting material in a weakly reducing atmosphere. As an example, a method of manufacturing a fluorescent material in the case that x=0.1 and y=0.30, in other words, when expressed by the compositional formula CaY_{0.6}Tb_{0.1}Re_{0.3}AlO₄ (Re is either Gd or La) is described below.

Firstly, for the starting material, a CaCO₃ reagent with a purity of 99.99% or higher, Y₂O₃ with a purity of 99.99% or higher, an α-Al₂O₃ reagent with a purity of 99.99% or higher, a Tb₄O₇ reagent with a purity of 99.9% or higher and Re₂O₃ (Re is either Gd or La) are mixed so as to be in the above composition ratio. In other words, in case of Example 2, CaCO₃, Y₂)₃, α-Al₂O₃, Tb₄O₇ and Gd₂O₃ are mixed in such a way that Ca, Y, Al, Tb and Gd may be at the molar ratio of 1:0.6:1:0.1:0.3. In case of Example 3, using La₂O₃ in place of Gd₂O₃, the mixture is made in such a way that Ca, Y, Al, Tb and La may be at the molar ratio of 1:0.6:1:0.1:0.3.

After that, blending dry or wet, they are baked at approximately 1200-1500° C. for approximately three hours or so and thereby a green light-emitting fluorescent material with one of the above compositions can be obtained.

Now, with a green light-emitting fluorescent material with a composition expressed by the general formula CaY_{1-x-y}TbₓRe_{y}AlO₄ (wherein Re is either Gd or La, and 0.005≦x≦0.5, 0.1≦y≦0.7 ), if the composition value x is less than the minimum value of x=0.005, a sufficient emission intensity cannot be attained. On the other hand, if the composition value x is greater than the maximum value of x=0.5, its emission intensity drops due to the concentration quenching and its use becomes less practicable. Further, when the composition value y is less than the minimum value of y=0.1, the effects shown in Example 2 or Example 3, that is, the effects that the emission intensity with the mercury emission line becomes increased and the afterglow time becomes shortened cannot be obtained. On the other hand, if the composition value y is greater than the maximum value of y=0.7, the crystal structure of the green light-emitting fluorescent material expressed by the general formula CaY_{1-x-y}TbₓRe_{y}AlO₄ (wherein Re is Gd and/or La) changes. For these reasons, the composition values of the green light-emitting fluorescent material according to the present embodiment are determined as above.

Further, while Example 2 and Example 3 are examples wherein Gd alone or La alone is substituted for Y, the present inventors established that even in the case that both Gd and La are substituted for Y, the same afore-mentioned effects as Example 2 and Example 3 have over Example 1 can be obtained.

### THIRD EMBODIMENT

The present inventors conducted further investigations and came to a conclusion that the complete replacement of yttrium with gadolinium and/or lanthanum which is, in Second Embodiment, substituted for yttrium in part, the emission characteristics equivalent to those of a green light-emitting fluorescent material expressed by the above general formula CaY₁₋ₓTbₓAlO₄ (wherein 0.005≦x≦0.5), and a green light-emitting fluorescent material expressed by the general formula CaY_{1-x-y}TbₓRe_{y}AlO₄ (wherein 0.005≦x≦0.5, Re=Gd or La and 0.1≦y≦0.7) can be obtained.

In particular, a green light-emitting fluorescent material having a composition expressed by the general formula CaGd_{1-x-y}La_{y}TbₓAlO₄ (wherein 0.005≦x≦0.5, 0≦y≦1−x ) is favored.

The crystal structure of the green light-emitting fluorescent material of the present embodiment is different from that of the green light-emitting fluorescent materials of First Embodiment and Second Embodiment and, thus, as described below, the structure of the excitation band is changed to show a higher efficiency for excitation at 254 nm. On the other hand, the emission characteristics including afterglow characteristic show little difference. Referring to Examples 4-7, the green light-emitting fluorescent materials of the present embodiment are described below.

Example 4 is a green light-emitting fluorescent material of the general formula CaGd_{1-x-y}La_{y}TbₓAlO₄ wherein x=0.1 and y=0.0, that is, CaGd_{0.9}Tb_{0.1}AlO₄.

Example 5 is a green light-emitting fluorescent material of the same general formula CaGd_{1-x-y}La_{y}TbₓAlO₄ wherein x=0.1 and y=0.3, that is, CaGd_{0.6}La_{0.3}Tb_{0.1}AlO₄.

Example 6 is a green light-emitting fluorescent material of the same general formula CaGd_{1-x-y}La_{y}TbₓAlO₄wherein x=0.1 and y=0.6, that is, CaGd_{0.3}La_{0.6}Tb_{0.1}AlO₄.

Example 7 is a green light-emitting fluorescent material of the same general formula CaGd_{1-x-y}La_{y}TbₓAlO₄ wherein x=0.1 and y=0.9, that is, CaLa_{0.9}Tb_{0.1}AlO₄.

FIG. 6 and FIG. 7 show the excitation spectra and the emission spectra for the green light-emitting fluorescent materials of Examples 4-7, respectively, each further showing the corresponding spectrum for the green light-emitting fluorescent material of Example 1 for comparison. Further, its excitation intensity with the mercury emission line at a wavelength of 254 nm is listed in Table 2. Hereat, for easy view, the emission spectra in FIG. 7 are displayed in such a way that every spectrum of a green light-emitting fluorescent material is shifted by a step in the longitudinal direction, but in any of these spectra, the emission intensity at a wavelength of 450 nm is actually 0 and the scale in ordinate used is one and the same.

As is evident from FIG. 6 and Table 2, in the green light-emitting fluorescent materials of Examples 4-7, while the excitation intensities with excitation light at a wavelength of 254 nm vary with the concentration of Gd and La added thereto, these intensities are all at least on the same level as the intensity of Example 1 and some of them even attain as high as those of Example 2 or Example 3.

Meanwhile, with respect to the emission, as is clear from in FIG. 7, the green light-emitting characteristics of having the main peak at an emission wavelength of 548 nm and sub-peaks at emission wavelengths of 487 nm and 585 nm are observed and the green light-emitting fluorescent materials of these examples have obviously the same emission characteristics as the green light-emitting fluorescent material of Example 1 expressed by the general formula CaY₁₋ₓTbₓAlO₄ (wherein 0.005≦x≦0.5).

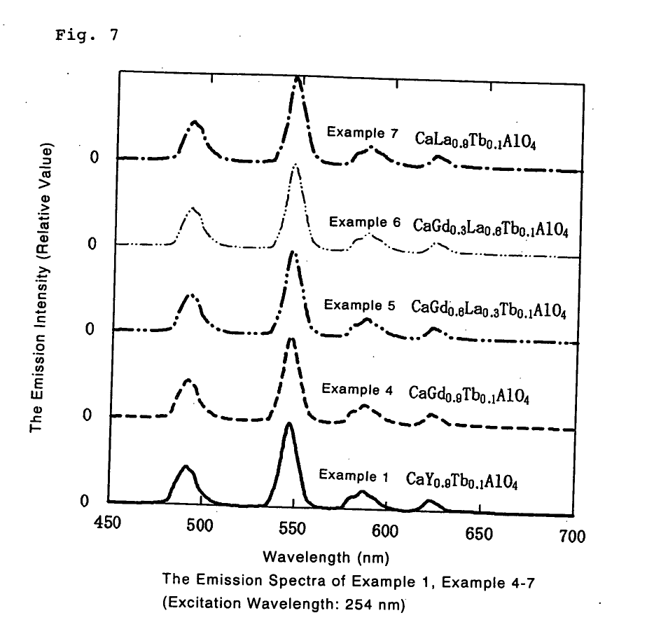

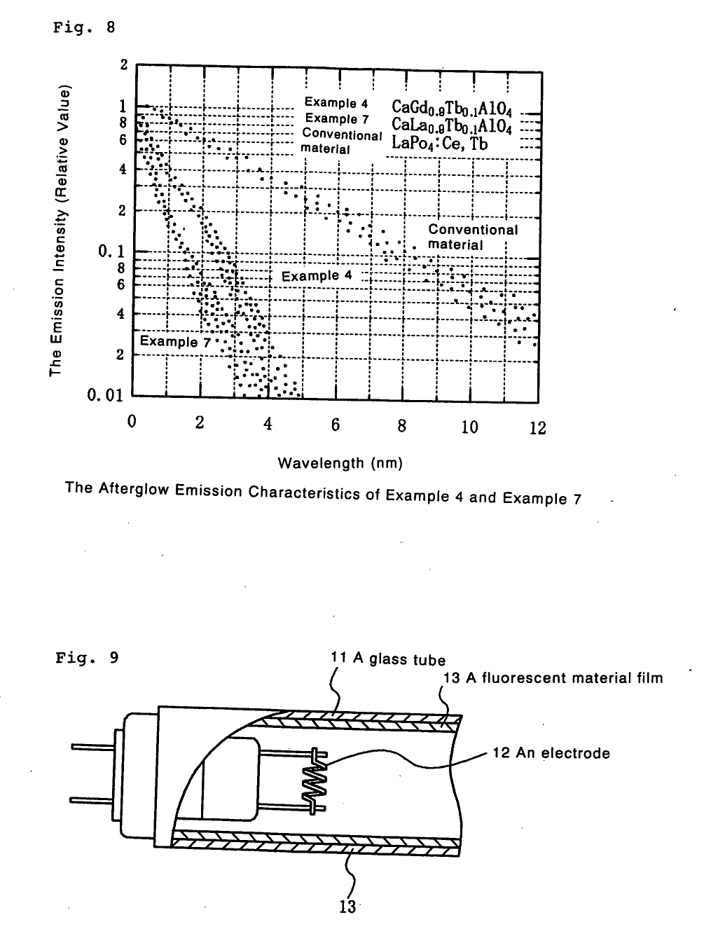

Next, in FIG. 8, there are shown the afterglow characteristics of the green light-emitting fluorescent materials of Example 4 and Example 8, with the afterglow characteristic of the conventional green light-emitting fluorescent material LaPO₄:Ce, Tb for comparison. Further, for the green light-emitting fluorescent materials of Examples 1-7, the afterglow times obtained from the measurements of the afterglow characteristics, respectively, are listed in Table 1. Hereat, the afterglow characteristic presented for “the conventional case” in FIG. 8 is the same as the afterglow characteristic presented for “the conventional case” in FIG. 2 and FIG. 4.

From FIG. 8 and Table 1, it is clear that, with their afterglow times being shorter than that of the green light-emitting fluorescent material of Example 1, the green light-emitting fluorescent materials of Examples 4-7 have short afterglow properties as good as or even better than the green light-emitting fluorescent materials of Examples 2 and 3.

Next, a method of manufacturing a green light-emitting fluorescent material of the present embodiment is described below. A green light-emitting fluorescent material with the afore-mentioned compositions CaGd_{1-x-y}La_{y}TbₓAlO₄ may be prepared by either the solid-state reaction method or the coprecipitation method, for instance, by baking the starting material in a weakly reducing atmosphere.

For example, using, for the starting material, a CaCO₃ reagent with a purity of 99.99% or higher, Y₂O₃ with a purity of 99.99% or higher, an α-Al₂O₃ reagent with a purity of 99.99% or higher, a Tb₄O₇ reagent with a purity of 99.9% or higher and Re₂O₃ (Re is either Gd or La), they are mixed so as to be in the above composition ratio.

In other words, in case of Example 5, CaCO₃, Gd₂O₃, La₂O₃, α-Al₂O₃ and Tb₄O₇ are mixed in such a way that Ca, Gd, La, Al and Tb may be at the molar ratio of 1:0.6:0.3:1:0.1.

After that, blending dry or wet, they are baked at approximately 1200-1500° C. for some hours (approximately three hours) and thereby a green light-emitting fluorescent material of Example 5 can be obtained.

Now, with a green light-emitting fluorescent material of the present embodiment expressed by the above general formula, if the composition value x is less than the minimum value of x=0.005, a sufficient emission intensity cannot be attained. On the other hand, if the composition value x is greater than the maximum value of x=0.5, its emission intensity drops due to the concentration quenching and its use becomes less practicable.

Further, the composition value y, which is described by 0≦y≦1x can be freely determined within this range, once the composition value x is given. For these reasons, the composition values of the green light-emitting fluorescent material according to the present embodiment are determined as above.

Accordingly, the present invention can provide a green light-emitting fluorescent material, which comprises, at least, calcium, yttrium, aluminum and oxygen, and utilizes terbium as an activator at an emission center, and thereby efficiently absorbs an ultraviolet light in a wavelength region around 240 nm and has the main emission peaks at 548 nm, 487 nm and 585 nm, and has an afterglow time as short as approximately ⅓ of the conventional green light-emitting fluorescent material.

Further, in the present invention, obviously through the substitution of gadolinium and/or lanthanum for a part or the whole of yttrium in the above composition with various ratios between gadolinium and lanthanum, the composition thereof can be freely changed so that characteristics in regard of the afterglow and the excitation intensity with the mercury emission line at a wavelength of 254 nm can be appropriately selected, according to the purpose.

TABLE 1
Afterglow Characteristics of Various Fluorescent Materials with the
excitation light at a wavelength of 266 nm

| | | Afterglow time for the |
|---|---|---|
| | | emission intensity |
| | | to fall to 1/10 of |
| Subject for the | | the initial magnitude |
| measurement | Composition | (ms) |
| Conventional | LaPO₄:Ce,Tb | 7.7 |
| material | | |
| First Embodiment | | |
| Example 1 | CaY_{0.9}Tb_{0.1}AlO₄ | 2.8 |
| Second Embodiment | | |
| Example 2 | CaY_{0.6}Tb_{0.1}Gd_{0.3}AlO₄ | 2.2 |
| Example 3 | CaY_{0.8}Tb_{0.1}La_{0.3}AlO₄ | 2.5 |
| Third Embodiment | | |
| Example 4 | CaGd_{0.9}Tb_{0.1}AlO₄ | 2.4 |
| Example 5 | CaGd_{0.6}La_{0.3}Tb_{0.1}AlO₄ | 2.2 |
| Example 6 | CaGd_{0.3}La_{0.6}Tb_{0.1}AlO₄ | 2.0 |
| Example 7 | CaLa_{0.9}Tb_{0.1}AlO₄ | 1.5 |

TABLE 2
Excitation Intensity of Various Fluorescent Materials with the
excitation light at a wavelength of 254 nm

| Subject for the | | Excitation |
|---|---|---|
| measurement | Composition | intensity (%) |
| First Embodiment | | |
| Example 1 | CaY_{0.9}Tb_{0.1}AlO₄ | 100 |
| Second Embodiment | | |
| Example 2 | CaY_{0.6}Tb_{0.1}Gd_{0.3}AlO₄ | 114 |
| Example 3 | CaY_{0.6}Tb_{0.1}La_{0.3}AlO₄ | 118 |
| Third Embodiment | | |
| Example 4 | CaGd_{0.9}Tb_{0.1}AlO₄ | 116 |
| Example 5 | CaGd_{0.6}La_{0.3}Tb_{0.1}AlO₄ | 119 |
| Example 6 | CaGd_{0.3}La_{0.6}Tb_{0.1}AlO₄ | 115 |
| Example 7 | CaLa_{0.9}Tb_{0.1}AlO₄ | 98 |

### FOURTH EMBODIMENT

Referring to FIG. 9, an example of a mercury fluorescent lamp, which is the Fourth Embodiment of the present invention, is described below.

FIG. 9 is a partially cutaway cross-sectional view, showing an example of a mercury fluorescent lamp according to the present embodiment. As shown in the drawing, a mercury lamp of the present example comprises a glass tube 11, a pair of electrodes 12, one of which is formed on each end of the glass tube, a fluorescent material film 13 coating the inner surface of the glass tube 11 and a mixed gas of the above mercury and an inert gas (not shown in the drawing) which is sealed in the glass tube. For the fluorescent material film 13, a fluorescent material film containing at least a green light-emitting fluorescent material CaY₁₋ₓTbₓAlO₄ of the present invention is used. This green light-emitting fluorescent material can be CaY_{1-x-y}TbₓRe_{y}AlO₄ (wherein Re is Gd and/or La), with Gd and/or La being substituted in part for Y that is one of its compositional elements. Further, the green light-emitting fluorescent material can be CaGd_{1-x-y}La_{y}TbₓAlO₄ wherein Ga and/or La is substituted for the whole of Y.

The fluorescent material of the present invention provides green luminescence so that when the fluorescent film 13 is solely formed of the fluorescent material of the present invention, the fluorescent lamp emits a green light with an afterglow shorter in duration than the conventional ones.

A requirement of a fluorescent lamp that emits white light can be met through the employment of a fluorescent material film formed of a mixture of three sorts of fluorescent materials, that is, red light-emitting, green light-emitting and blue light-emitting fluorescent materials. By utilizing a green light-emitting fluorescent material of the present invention as the green light-emitting fluorescent material among these three sorts of fluorescent materials, that is, red light-emitting, green light-emitting and blue light-emitting fluorescent materials, a fluorescent lamp with green light component whose afterglow is shorter in duration than the conventional ones may be provided.

For the red light-emitting fluorescent material, any conventional material such as Y₂O₃:Eu or Y (P, V)O₄:Eu can be used. As for the blue light-emitting fluorescent material, for instance, BaMgAl₁₀O₁₇:Eu or Sr₅(PO₄)₃ Cl:Eu can be utilized.

While the description in the present embodiment is made so far, taking a straight tube-shaped type fluorescent lamp as an example, the fluorescent lamp can obviously take any form including ring shape, compact type and form with a cap similar to the incadescent lamp. Further, an appropriate choice of the mixing ratio of the three sorts of fluorescent materials, that is, red light-emitting, green light-emitting and blue light-emitting fluorescent materials, enables the fluorescent lamp to emit a light with a hue of a warm color or a cold color.

### INDUSTRIAL APPLICATION

The present invention is particularly well suited for application to either the mercury fluorescent lamp for general illumination, wherein the inverter electronic driver circuit which makes little flicker is used in place of the driver circuit at a frequency of 50/60 Hz with the stabilizer or the cold-cathode mercury fluorescent lamp used for the back lighting in the liquid-crystal display apparatus.

What is claimed is:

1. A green light-emitting fluorescent material comprising, at least, calcium, yttrium, aluminum and oxygen, with terbium as an activator at an emission center.

2. A green light-emitting fluorescent material according to claim 1, which has a composition expressed by the general formula CaY₁₋ₓTbₓAlO₄ (wherein 0.005≦x≦0.5).

3. A green light-emitting fluorescent material comprising, at least, calcium, yttrium, aluminum and oxygen, with terbium as an activator at an emission center, wherein gadolinium and/or lanthanum is substituted for yttrium in part.

4. A green light-emitting fluorescent material according to claim 3, which has a composition expressed by the general formula CaY_{1-x-y}TbₓRe_{y}AlO₄ (wherein Re is at least one sort of elements selected between Gd and La, and 0.005≦x≦0.5, 0.1≦y≦0.7).

5. A green light-emitting fluorescent material comprising, at least, calcium, gadolinium and/or lanthanum, aluminum and oxygen, with terbium as an activator at an emission center.

6. A green light-emitting fluorescent material according to claim 5, which has a composition expressed by the general formula CaGd_{1-x-y}La_{y}TbₓAlO₄ (wherein 0.005≦x≦0.5, 0≦y≦1−x).

7. A green light-emitting fluorescent material according to one of claims 1-6, which emits a light, being excited by an ultraviolet light in a wavelength range around 240 nm and has green light-emitting characteristics of having a main peak at an emission wavelength of 548 nm and sub-peaks at emission wavelengths of 487 nm and 585 nm,

8. A fluorescent lamp with a fluorescent material film being formed on the inner surface of a glass tube in which mercury and an inert gas are sealed; wherein
said fluorescent material film contains at least a green light-emitting fluorescent material comprising, at least, calcium, yttrium, aluminum and oxygen, and utilizing terbium as an activator.

9. A fluorescent lamp according to claim 8, wherein said green light-emitting fluorescent material has a composition expressed by the general formula CaY₁₋ₓTbₓAlO₄ (wherein 0.005≦x≦0.5).

10. A fluorescent lamp with a fluorescent material film being formed on the inner surface of a glass tube in which mercury and an inert gas are sealed; wherein
said fluorescent material film contains at least a green light-emitting fluorescent material comprising, at least, calcium, yttrium, aluminum and oxygen, and utilizing terbium as an activator, wherein gadolinium and/or lanthanum is substituted for yttrium in part.

11. A fluorescent lamp according to claim 10, wherein said green light-emitting fluorescent material has a composition expressed by the general formula CaY_{1-x-y}TbₓRe_{y}AlO₄ (wherein Re=Gd and/or La, and 0.005x≦0.5, 0.1≦y≦0.7 ).

12. A fluorescent lamp with a fluorescent material film being formed on the inner surface of a glass tube in which mercury and an inert gas are sealed; wherein
said fluorescent material film contains at least a green light-emitting fluorescent material comprising, at least, calcium, gadolinium and/or lanthanum, aluminum and oxygen, and utilizing terbium as an activator.

13. A fluorescent lamp according to claim 12, wherein said green light-emitting fluorescent material has a composition expressed by the general formula CaGd_{1-x-y}La_{y}TbₓAlO₄ (wherein 0.005≦x≦0.5, 0≦y≦1x).

14. A fluorescent lamp according to one of claims 8-13, which has a fluorescent material film formed of a mixture of three sorts of fluorescent materials of a red light-emitting fluorescent material, a green light-emitting fluorescent material and a blue light-emitting fluorescent material.
